(19) United States
(12) Patent Application Publication
(10) Pub. No.: US 2012/0006142 A1
(43) Pub. Date: Jan. 12, 2012

(54) TILT HINGE BRACKET OF STEERING COLUMN FOR VEHICLE AND STEERING COLUMN FOR VEHICLE HAVING THE SAME

(75) Inventor: Sung Joon JUNG, Seoul (KR)

(73) Assignee: Mando Corporation

(21) Appl. No.: 13/180,987

(22) Filed: Jul. 12, 2011

(30) Foreign Application Priority Data
Jul. 12, 2010 (KR) 10-2010-0066743

(51) Int. Cl. B62D 1/19; F16F 15/00; F16M 13/02

(52) U.S. Cl. 74/493; 248/636

(57) ABSTRACT

Disclosed are a tilt hinge bracket of a vehicle steering column and a steering column for a vehicle having the same. The disclosed tilt hinge bracket performs a tilt operation of a steering column without a hinge part as a rotation center during a tilt operation of the steering column, and has a rigid structure that can support the steering column. This can reduce the number of parts and simplify manufacturing and assembling processes.

### CROSS-REFERENCE TO RELATED APPLICATION

This application claims priority from and the benefit under 35 U.S.C. §119(a) of Korean Patent Application No. 10-2010-0066743, filed on Jul. 12, 2010, which is hereby incorporated by reference for all purposes as if fully set forth herein.

### BACKGROUND OF THE INVENTION

1. Field of the Invention

The present invention relates to a tilt hinge bracket and a steering column for a vehicle having the same. More particularly, the present invention relates to a tilt hinge bracket for a vehicle steering column, and a steering column for a vehicle having the same, in which the tilt hinge bracket performs a tilt operation of a steering column without a hinge part as a rotation center during tilt operation of the steering column, and has a rigid structure and an impact-absorbing structure that can support the steering column, thereby reducing the number of parts and simplifying manufacturing and assembling processes.

2. Description of the Prior Art

As generally known in the art, a steering apparatus for a vehicle is an apparatus which allows a driver to freely change an advancing direction of the vehicle. In other words, the apparatus is an assist apparatus which allows a driver to freely change a rotation center of turning of a front wheel of the vehicle and to advance the vehicle in a required direction. In such a steering apparatus for a vehicle, a steering power generated by a driver's operation of a steering wheel is transferred to a rack pinion mechanism through a steering shaft of a steering column, and finally changes the direction of both-side wheels.

Also, for the convenience of a driver, a steering apparatus for a vehicle may additionally include a convenience function in a steering column, such as a telescope function or a tilt function. A tilt device is for adjusting a fixing angle of a steering wheel, and a telescope device is formed by insertion of two hollow pipes in such a manner that it can be extended or retracted in an axial direction. The telescope device also has a function of absorbing impact energy when a steering shaft and a steering column collapse by car collision.

Accordingly, a steering column is divided into a general steering column without any convenience function, and a telescope-type steering column with a telescope function or a tilt-type steering column with a tilt function. In some cases, a telescope-type steering column may be added with a tilt function. Through such a convenience function, a driver can smoothly perform a steering action by adjusting a protrusion size or a tilt angle of a steering wheel according to his height or his body size.

FIG. 1 is a schematic view illustrating a conventional steering apparatus for a vehicle. In a conventional steering apparatus for a vehicle, a lower end of a steering shaft 130 is connected to a gear box 180, in which the steering shaft 130 is designed to be connected, with a slant at a predetermined angle, to the gear box 180 under the condition of a vehicle structure. Accordingly, in order to satisfy such a condition, the steering shaft 130 is connected via a universal joint, and employs an intermediate shaft 120 including a tube 100 and a shaft 110.

The intermediate shaft 120 is a device having one side connected to the steering shaft 130 connected to the steering wheel 170, and the other side connected to the gear box 180, which is to transfer a rotation force generated by a steering wheel 170 to wheels via the gear box 180.

A steering column 150 includes a column tube 147, an upper mounting bracket 160, and a lower mounting bracket 165. The column tube 147 may include an outer tube 145 and an inner tube 140. The outer tube 145 is formed at the steering wheel 170's side. Within the outer tube 145, the inner tube 140 is disposed, which can be inserted into the outer tube 145 by impact due to its smaller diameter than that of the outer tube 145. The outer tube 145 and the inner tube 140 are formed as hollow tubes so that the steering shaft 130 can be smoothly rotated.

A dust cover 105 is fixed on a dash panel 115 and is used for blocking noise or the like coming into the interior side from an engine room.

However, such a conventional general steering apparatus for a vehicle has a problem in that in order to add a tilt function, besides an upper mounting bracket and a lower mounting bracket, an additional hinge part for rotating and supporting a steering column has to be additionally manufactured and assembled.

Also, there is a problem in that in order to absorb impact energy caused by car collision, the steering column has to be provided with an additional impact absorbing structure, or an additional impact absorbing part has to be manufactured and assembled.

Also, it is required to additionally manufacture and assemble an additional part for supporting a vehicle steering column and fixing it on a vehicle body while keeping rigidity. Thus, there is a problem in that the number of parts is increased and manufacturing and assembling processes are complicated.

### SUMMARY OF THE INVENTION

Accordingly, the present invention has been made to solve the above-mentioned problems occurring in the prior art, and an object of the present invention is to provide a tilt hinge bracket which can perform a tilt operation of a steering column without a hinge part as a rotation center during tilt operation of the steering column, and have a rigid structure and an impact-absorbing structure that can support the steering column, thereby reducing the number of parts and simplifying manufacturing and assembling processes.

In accordance with an aspect of the present invention, there is provided a tilt hinge bracket of a vehicle steering column, the tilt hinge bracket including: a column plate coupled with a steering column and formed with a column through hole through which the steering column is passed; a bending plate bent at a predetermined angle with respect to the column plate and formed with a steering shaft through hole through which a steering shaft is passed; and a mounting plate bent at a predetermined angle with respect to the bending plate and coupled with a vehicle body, wherein when the steering column is tilt-operated, a bent portion between the column plate and the bending plate or a bent portion between the bending plate and the mounting plate is elastically deformed, thereby forming a tilt angle of the steering column and absorbing impact energy.

In accordance with another aspect of the present invention, there is provided a vehicle steering column including: a steering shaft connected to a steering wheel; a column tube within which the steering shaft is mounted and rotatably coupled; an upper mounting bracket which is coupled with the column tube and fixes the steering column on a vehicle body; and a tilt hinge bracket, wherein the tilt hinge bracket includes: a column plate coupled with the steering column and formed with a column through hole, in which through the column through hole, the steering column is passed; a bending plate bent at a predetermined angle with respect to the column plate and formed with a steering shaft through hole, in which through the steering shaft through hole, the steering shaft is passed; and a mounting plate bent at a predetermined angle with respect to the bending plate, and coupled with the vehicle body, wherein when the steering column is tilt-operated, a bent portion between the column plate and the bending plate or a bent portion between the bending plate and the mounting plate is elastically deformed, thereby forming a tilt angle of the steering column.

According to the present invention, the tilt hinge bracket can perform a tilt operation of a steering column without a hinge part as a rotation center during tilt operation of the steering column, and has a rigid structure and an impact-absorbing structure that can support the steering column, thereby reducing the number of parts and simplifying manufacturing and assembling processes.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view illustrating a conventional steering apparatus of a vehicle;

FIGS. 2 and 3 are perspective views illustrating a tilt hinge bracket according to one embodiment of the present invention;

FIG. 4 is a front view illustrating a tilt hinge bracket according to one embodiment of the present invention;

FIG. 5 is a side view illustrating a vehicle steering column provided with a tilt hinge bracket according to one embodiment of the present invention; and

FIG. 6 is a side view illustrating a state where a tilt hinge bracket according to one embodiment of the present invention is tilt-operated.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

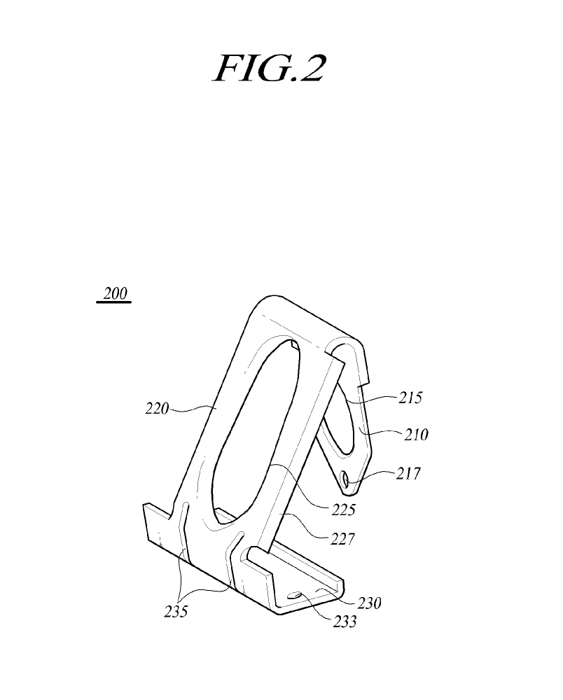

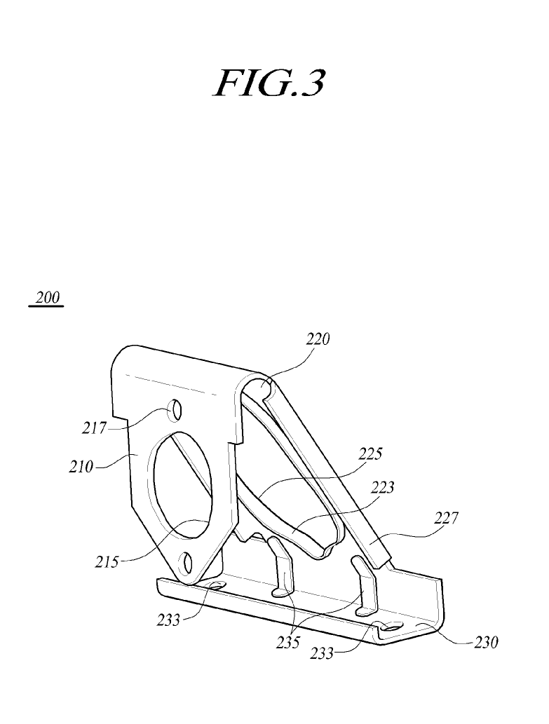

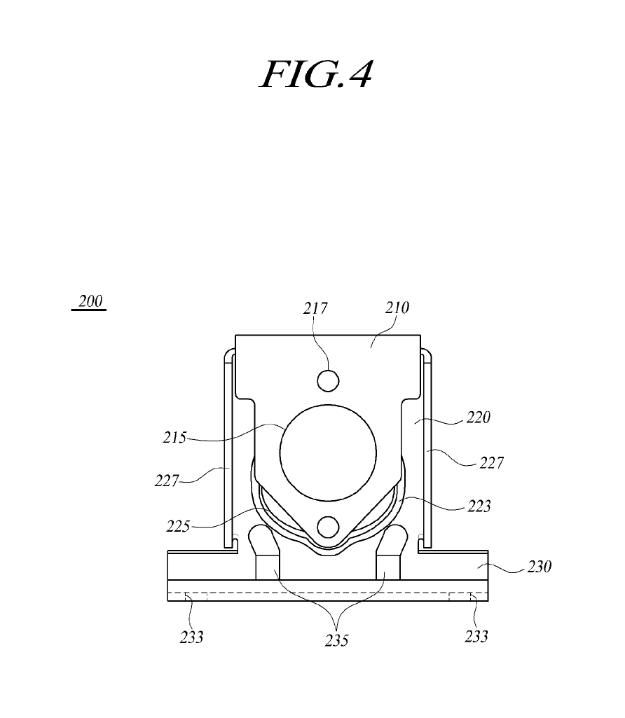

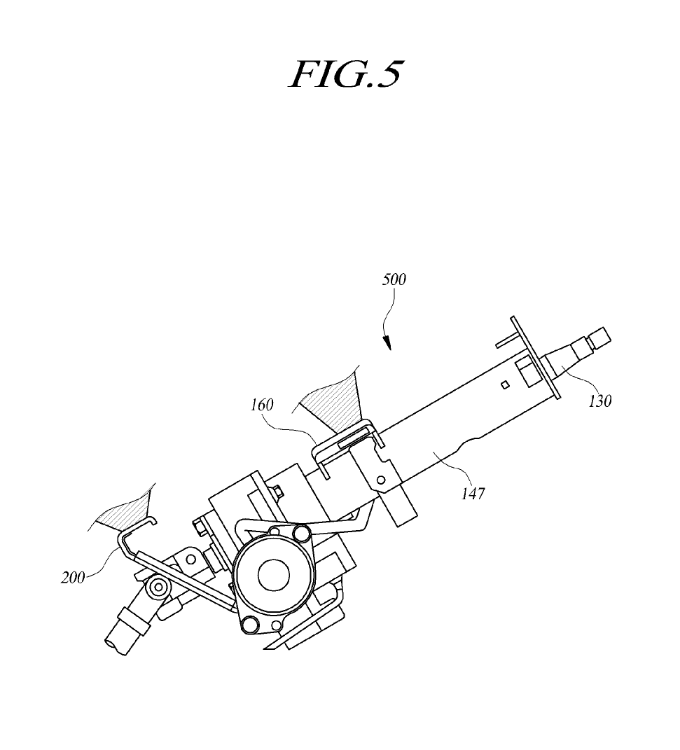

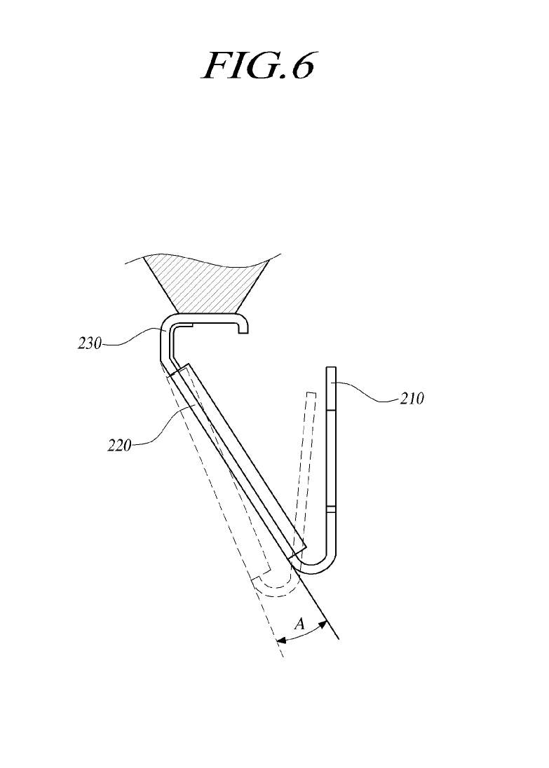

FIGS. 2 and 3 are perspective views illustrating a tilt hinge bracket according to one embodiment of the present invention, FIG. 4 is a front view illustrating a tilt hinge bracket according to one embodiment of the present invention, FIG. 5 is a side view illustrating a vehicle steering column provided with a tilt hinge bracket according to one embodiment of the present invention, and FIG. 6 is a side view illustrating a state where a tilt hinge bracket according to one embodiment of the present invention is tilt-operated.

As shown in the drawings, a tilt hinge bracket 200 of a vehicle steering column, according to one embodiment of the present invention, includes: a column plate 210 coupled with a steering column 500 and formed with a column through hole 215, in which through the column through hole 215, the steering column 500 is passed; a bending plate 220 bent at a predetermined angle with respect to the column plate 210 and formed with a steering shaft through hole 225, in which through the steering shaft through hole 225, a steering shaft is passed; and a mounting plate 230 bent at a predetermined angle with respect to the bending plate 220, and coupled with a vehicle body. When the steering column 500 is tilt-operated, the bent portion between the column plate 210 and the bending plate 220 or the bent portion between the bending plate 220 and the mounting plate 230 is elastically deformed, thereby forming a tilt angle A of the steering column 500 and absorbing the impact.

In other words, the tilt hinge bracket 200 according to one embodiment of the present invention performs a tilt operation without a hinge part as a rotation shaft during a tilt operation of the general steering column 500, and has a rigid structure and an impact-energy absorbing structure which can support the steering column 500.

The tilt hinge bracket 200 mainly includes: the column plate 210 mounted in the steering column 500, which performs a role of supporting the steering column 500; the bending plate 220 bent with respect to the column plate 210; and the mounting plate 230 bent with respect to the bending plate 220, which is coupled with the vehicle body.

The column plate 210 is coupled with the steering column 500, and has the column through hole 215 at the center thereof, in which through the column through hole 215, the steering column 500 is passed. Thus, it is designed to sustain the weight of the steering column 500 and also support the steering column 500 during a tilt operation.

Also, the column plate 210 coupled with the steering column 500 has a column fastening hole 217 in the vicinity of the column through hole 215 so that it can be fastened with the steering column 500 through a screw, a bolt or the like.

The bending plate 220 is bent at a predetermined angle with respect to the column plate 210, and has at the center thereof, the steering shaft through hole 225 through which a steering shaft 130 is passed. Herein, the steering shaft through hole 225 is communicated with the column through hole 215. Thus, through the holes, the steering column 500, and the steering shaft 130 connected to the lower side of the steering column via a universal joint are passed and coupled, while steered.

Herein, at least one of the column through hole 215 of the column plate 210, and the steering shaft through hole 225 of the bending plate 220 is provided with a reinforcing flange 223 bending at a predetermined angle at the edge thereof. Thus, it can keep rigidity and can be elastically deformed during tilt operation of the steering column 500, and can absorb impact energy during car collision.

Also, the mounting plate 230 bent at a predetermined angle with respect to the bending plate 220 couples the lower side of the steering column 500 with the vehicle body, while the upper side of the steering column 500 is coupled with the vehicle body by an upper mounting bracket 160. The mounting plate 230 together with the upper mounting bracket 160 sustains the steering column 500. Also, during a tilt operation, the mounting plate 230 is supported by the vehicle body while supporting the elastic deformation of the tilt hinge bracket 200.

The mounting plate 230 is formed with a vehicle body fixing hole 233 so that it can be fastened with the vehicle body through a screw, a bolt, or the like.

Accordingly, the tilt hinge bracket 200 is fixed on the vehicle body and supports the load of the steering column 500 while supporting elastic deformation of the bent portion between the column plate 210 and the bending plate 220 or the bent portion between the bending plate 220 and the mounting plate 230 during tilt operation of the steering column 500 coupled with the column plate 210.

Also, in the bent portion between the bending plate 220 and the mounting plate 230, at least one embossing 235 is formed so as to support elastic deformation. This complements the rigidity supporting the elastic deformation of the tilt hinge bracket 200.

Further, the bending plate 220 is provided with a reinforcing flange 227 bending at a predetermined angle at one side edge or both side edges thereof so as to support elastic deformation. This complements the rigidity when the tilt hinge bracket 200 is elastically deformed.

Also, the bent portion between the column plate 210 and the bending plate 220 is curvedly formed. This also complements the rigidity when the tilt hinge bracket 200 is elastically deformed.

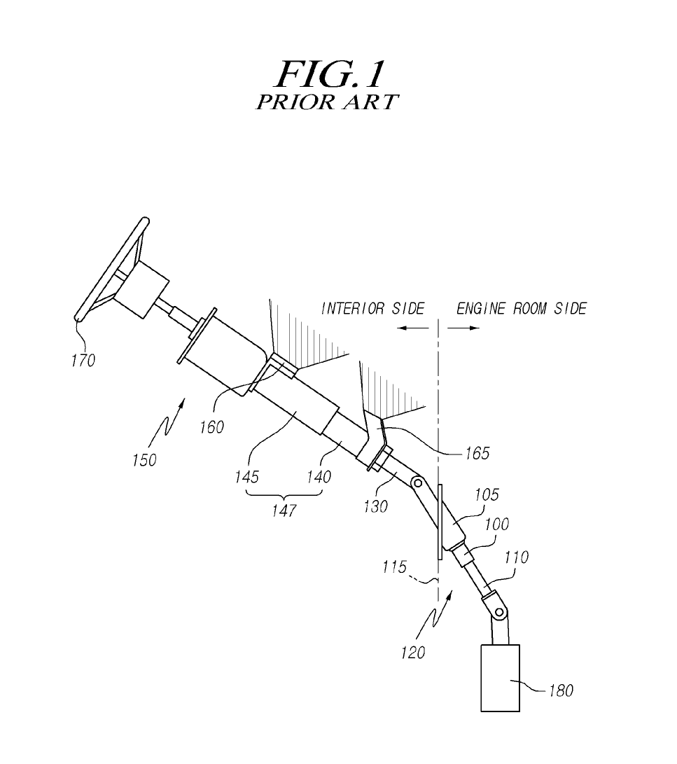

The tilt hinge bracket 200 according to one embodiment of the present invention together with the steering shaft 130, a column tube 147, the upper mounting bracket 160, and the like, constitutes the steering column of a vehicle. The steering shaft is coupled with the steering column and is connected to a steering wheel (see numeral 170 in FIG. 1). Within the column tube 147, the steering shaft 130 is mounted and rotatably coupled. The upper mounting bracket 160 is coupled with the column tube 147 and fixes the steering column on the vehicle body.

According to the present invention, the tilt hinge bracket with the structure and the shape, as described above, performs a tilt operation of a steering column without a hinge part as a rotation center during the tilt operation of the steering column, and has a rigid structure and an impact-absorbing structure that can support the steering column. This can reduce the number of parts and simplify manufacturing and assembling processes.

Even if it was described above that all of the components of an embodiment of the present invention are coupled as a single unit or coupled to be operated as a single unit, the present invention is not necessarily limited to such an embodiment.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. A tilt hinge bracket of a vehicle steering column, the tilt hinge bracket comprising:
a column plate coupled with a steering column and formed with a column through hole through which the steering column is passed;
a bending plate bent at a predetermined angle with respect to the column plate and formed with a steering shaft through hole through which a steering shaft is passed; and
a mounting plate bent at a predetermined angle with respect to the bending plate and coupled with a vehicle body,
wherein when the steering column is tilt-operated, a bent portion between the column plate and the bending plate or a bent portion between the bending plate and the mounting plate is elastically deformed, thereby forming a tilt angle of the steering column and absorbing impact energy.

2. The tilt hinge bracket as claimed in claim 1, wherein in the bent portion between the bending plate and the mounting plate, at least one embossing is formed so as to support elastic deformation.

3. The tilt hinge bracket as claimed in claim 1, wherein the bending plate is provided with a reinforcing flange bending at a predetermined angle at one side edge or both side edges of the bending plate so as to support elastic deformation.

4. The tilt hinge bracket as claimed in claim 1, wherein the bent portion between the column plate and the bending plate is curvedly formed.

5. The tilt hinge bracket as claimed in claim 1, wherein at least one of the column through hole and the steering shaft through hole is provided with a reinforcing flange bending at a predetermined angle at an edge thereof.

6. A vehicle steering column comprising:
a steering shaft connected to a steering wheel;
a column tube within which the steering shaft is mounted and rotatably coupled;
an upper mounting bracket which is coupled with the column tube and fixes the steering column on a vehicle body; and
a tilt hinge bracket,
wherein the tilt hinge bracket comprises: a column plate coupled with the steering column and formed with a column through hole, in which through the column through hole, the steering column is passed; a bending plate bent at a predetermined angle with respect to the column plate and formed with a steering shaft through hole, in which through the steering shaft through hole, the steering shaft is passed; and a mounting plate bent at a predetermined angle with respect to the bending plate, and coupled with the vehicle body,
wherein when the steering column is tilt-operated, a bent portion between the column plate and the bending plate or a bent portion between the bending plate and the mounting plate is elastically deformed, thereby forming a tilt angle of the steering column and absorbing impact energy.
